(19) United States
(12) Patent Application Publication
(10) Pub. No.: US 2005/0058746 A1
(43) Pub. Date: Mar. 17, 2005

(54) Process for producing vodka

(76) Inventor: Harlen Wheatley, Frankfort, KY (US)

Correspondence Address: BANNER & WITCOFF, LTD., TEN SOUTH WACKER DRIVE, SUITE 3000, CHICAGO, IL, 60606, US

(21) Appl. No.: 10/660,958

(22) Filed: Sep. 12, 2003

(51) Int. Cl. C12G 1/00

(52) U.S. Cl. 426/12

(57) ABSTRACT

A small batch process for producing high quality, smooth tasting vodka.

### FIELD OF THE INVENTION

The present invention relates to a process for producing vodka. More particularly, the present invention relates to a small batch process for producing high quality, smooth tasting vodka.

### BACKGROUND OF THE INVENTION

Vodka is one of the most popular spirits sold and consumed in America, accounting for more than 20% of all distilled spirits sales and consumption. Vodka is a non-aged neutral spirit that can be distilled from potatoes, rye, wheat, barley, corn, and many other fermentable materials.

The majority of vodka sold and consumed in the United States today, however, is not distilled by the bottler, rectifier or distributor. Most bottlers, rectifiers, and distributors of vodka forego the distillation step, and instead, purchase 190 proof grain neutral spirits (GNS) as a by-product of commercial continuous ethanol distillation plants. Those bottlers, rectifiers, and distributors simply add water and flavoring to the 190 GNS before bottling and selling the resulting product as vodka.

Those vodkas, however, have significant amounts of undesirable alcohols and other products that are known to impart negative flavors and odors to the vodka and contribute to hangovers. For example, gas chromatograph analyses shown in FIGS. 1-3 reveal significant concentrations of undesirable alcohols and other products in three different vodkas sold in the United States. Those undesirable alcohols and other products typically have low and high boiling points and include: acetaldehyde, propionaldehyde, methyl acetate, methanol, butyraldehyde, ethyl acetate, methyl propionate, isopropanol, 2-proponal, allyl alcohol, 1-propanonl, butanol, ethyl propionate, propyl acetate, 3 methyl-2-butonal, isobutyl acetate, 3-methyl-1-butonal, isoamyl alcohol, isobutyl propionate, isoamyl acetate, butyl propionate, heptanol, furfuryl alcohol, methyl heptanoate, ethyl hexadecanoate, phenyl acetate, and ethyl hexadecanoate. As a result, those vodkas are low quality with poor taste and odor.

Thus, a need exists for a method for producing high quality vodka that contains low levels of the undesirable alcohols and other products. The present invention fills the aforementioned need. In particular, the process of the present invention produces high quality vodka, which contains minimal amounts of the undesirable alcohols and other products that are know to impart negative flavors and odors and contribute to hangovers.

### BRIEF DESCRIPTION OF THE DRAWING

The foregoing aspects and many of the advantages of the present invention will become readily appreciated by reference to the following detailed description of the preferred embodiment, when taken in conjunction with the accompanying drawings, wherein:

FIGS. 1-3 are gas chromatograph analyses of three different exemplary vodkas sold in the United States; and

FIG. 4 is a chromatograph analysis of the vodka produced from the process of the present invention.

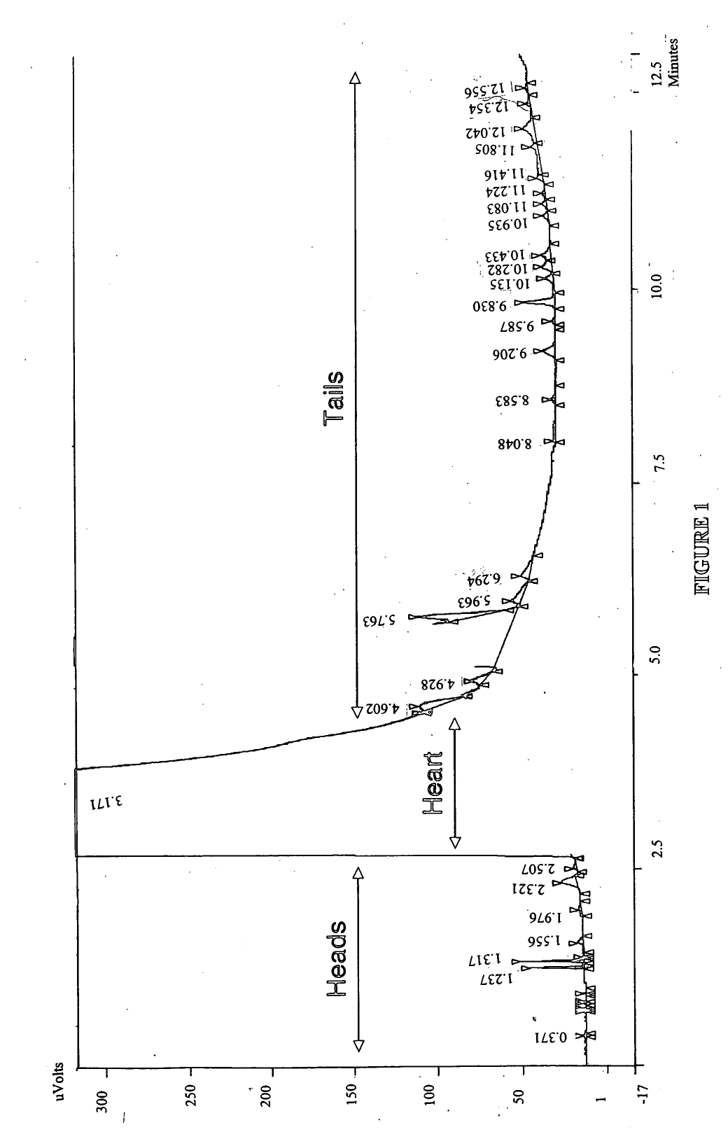

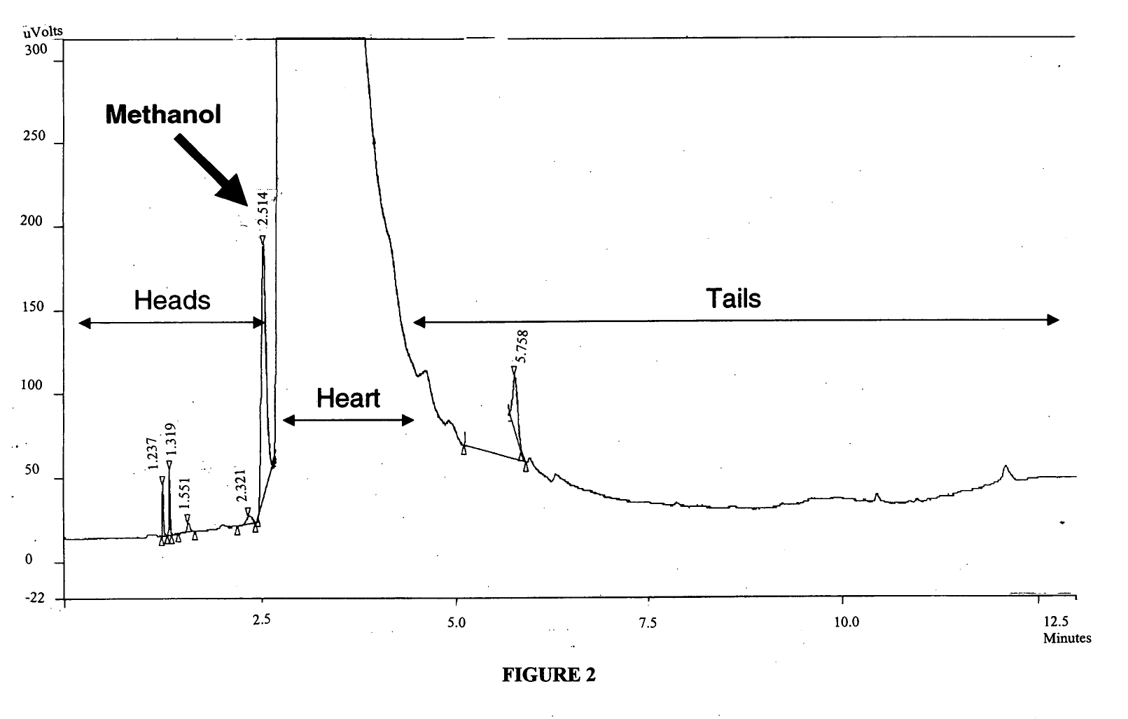

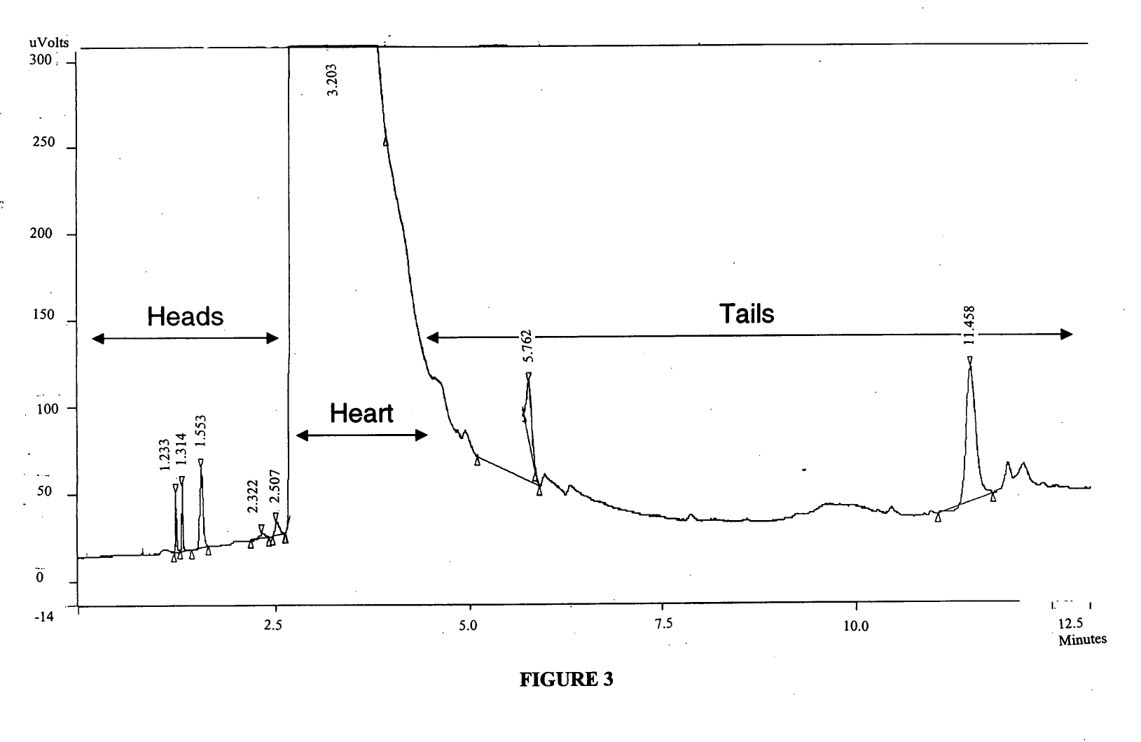

### DETAILED DESCRIPTION OF THE INVENTION

For a better understanding of the present invention, reference may be had to the following detailed description taken in conjunction with the accompanying drawings. The present invention is a process for producing high quality vodka. The process of the present invention begins with the selection of the grain used to produce the vodka. Preferably, whole, unbroken organic white corn having a moisture content below 14.0% is used in the process. The process of producing high quality vodka from the organic white corn generally comprises six steps.

In step 1 or the milling step, the organic white corn is milled to expose the starches in the corn and prepare the corn for the cooking and fermentation steps. In the milling step, the organic white corn is passed though one or more hammer mills that grind the white corn into a corn powder, which is typically referred to as corn mash. For example, hammer mills containing 160 hammers traveling at approximately 3,600 RPM may be used to mill the white corn into corn mash. Preferably, the present invention utilizes two Sprout Waldron Hammer Mills to mill the white corn into corn mash.

After the white corn is milled, the corn mash passes through a screening step to screen out all corn flour particles above 5/32 of an inch. Preferably, the screening step utilizes a #10 screen to ensure that the corn mash used in the cooking step does not contain corn particles larger than 5/32 of an inch. If particles larger than 5/32 of an inch are used in the cooking step, the conversion of starch to sugar/glucose is typically reduced.

In step 2 or the cooking step, the corn mash is transferred to pressure cooker where the corn mash is mixed with pre-heated water to liquefy the corn mash. The pre-heated water is preferably 110° F. The pressure cookers preferably operate at or below 240° F. at 20 psi. If the corn mash is cooked at a temperature above 240° F., the conversion of starch to sugar/glucose is typically reduced. The use of a pressurized cooker, as opposed to non-pressurized cooker, allows for a faster and more consistent rate of conversion of starch to sugar/glucose.

In the pressure cooker, the liquefied corn mash is brought to a boil and continuously stirred for approximately one hour. The pressure cooker contains a large agitator or stirring shaft for continuously stirring the liquefied corn mash. The corn mash is continuously stirred during the cooking step to ensure a consistent conversion of starch to sugar/glucose. After the corn mash is cooked for approximately one hour, the corn mash is transferred to a circulation tank. The circulation tank preferably maintains the corn mash at an even temperature of about 80° F. for approximately 30-40 minutes before the corn mash is transferred to the a fermenter. Maintaining the corn mash at an even temperature throughout provides for a more consistent fermentation during the fermentation process.

In step 3 or the fermentation step, the cooked corn mash is transferred to a fermenter operating at approximately 68-70° F. The fermentation step utilizes a cold water, slow fermentation technique. First, chilled water and yeast are added to the corn mash. The addition of chilled water lowers the corn mash to a temperature of 68-70 degrees Fahrenheit. Furthermore, the addition of water thins the corn mash to allow a consistent mixing of the yeast with the corn mash.

Second, the fermentation of the corn mash proceeds naturally without the use of any heating apparatus to speed up the process. The yeast converts the sugars in the corn mash to various alcohols and carbon dioxide. This fermentation process causes the undesirable solids in the corn mash to sink to the bottom of the fermenter. As the undesirable solids sink, carbon dioxide bubbles resulting from the fermentation process rise to the top. As a result, the corn mash is naturally stirred or mixed by the sinking solids and the rising carbon dioxide bubbles. The corn mash is fermented for about 5 days. The fermented corn mash, commonly referred to as beer, contains approximately 7.0% by volume alcohol as well as the non-fermentable solids from the corn and the yeast cells.

Step 4 or the distillation step of the present invention is divided into seven distillations occurring in four different stills to concentrate the alcohol in the beer. Repeated distillation is necessary to remove unwanted impurities from the vodka produced from the present invention. In the first distillation, the beer is transferred from the fermenters to the top of a beer still. The beer still is preferably 37.5 ft. high and 7 ft. in diameter and contains 16 trays or plates. The beer descends by gravity from the top of the beer still through the series of trays or plates. The bear heats up when it contacts steam rising from the bottom of the still. A reboiler at the bottom of the closed column still provides the vapor stream. The trays or plates are configured to provide an equal distribution and to maximize the contact time between the beer and the steam as the beer descends. When the beer meets the rising steam, the alcohol contained in the beer vaporizes and travels to the top of the beer still, and the residual water and other remaining solids in the beer continue to the bottom of the beer still.

The residual water and other remaining solids are commonly referred to as stillage. The stillage is a natural and nutritious waste produce that may be used as fodder for animals, such as cattle and horses. The vaporized alcohol is collected at the top of the beer still and transferred to a copper condenser. The condenser cools and condenses the vaporized alcohol. The liquid produced from the first distillation is commonly referred to as phlegm and is approximately 60% by volume alcohol or 120 proof.

The phlegm produced by the first distillation is transferred from the copper condenser to the kettle still for the second distillation. The kettle still contains heating coils or a heating apparatus to heat the phlegm to further separate certain alcohols from the water contained in the phlegm. As the heating coils apply heat to the liquid, the alcohols with a lower boiling point, vaporize first, followed by the alcohols with medium boiling points and high boiling points. When the alcohols vaporize, they flow directly into a closed column still for the second distillation. The mixture resulting from the first distillation is approximately 80% by volume alcohol or 190 proof.

In the third distillation, the alcohols resulting from the second distillation are transferred to a closed column still and heated. The closed column still is preferably pressurized and maintained at a temperature between 170-174° F. The vaporized alcohols are collected and condensed to a distillate stream and returned or refluxed back into the closed column still. The composition of the remaining mixture and the distillate are functions of time. As the reflux time (i.e., the time in which the distillate is returned to the closed column still as reflux) increases, the vapor concentration of low boiling point alcohols and other low boiling point materials increase in the top of the closed column still. The reflux time is dependent on batch size. Table 1 contains exemplary reflux times at constant temperature and pressure that may be used in the present invention.

TABLE 1

| Batch Size (gallons) | Reflux Time (hours) |
|---|---|
| Less than or equal to 20,000 | Greater than or equal to 1.5 hours |
| Less than or equal to 25,000 | Greater than or equal to 2.0 hours |
| Less than or equal to 30,000 | Greater than or equal to 2.5 hours |
| Less than or equal to 35,000 | Greater than or equal to 3.0 hours |
| Less than or equal to 40,000 | Greater than or equal to 3.5 hours |
| Less than or equal to 45,000 | Greater than or equal to 4.0 hours |

The low boiling point alcohols and other low boiling point materials are undesirable in significant quantities. Thus, the objective is to remove as many of undesirable alcohols and materials from the vodka as possible. Increasing the reflux time allows those alcohols and materials to be removed from the vodka quicker and more efficiently. In turn, the total yield of the vodka produced from the present invention is increased.

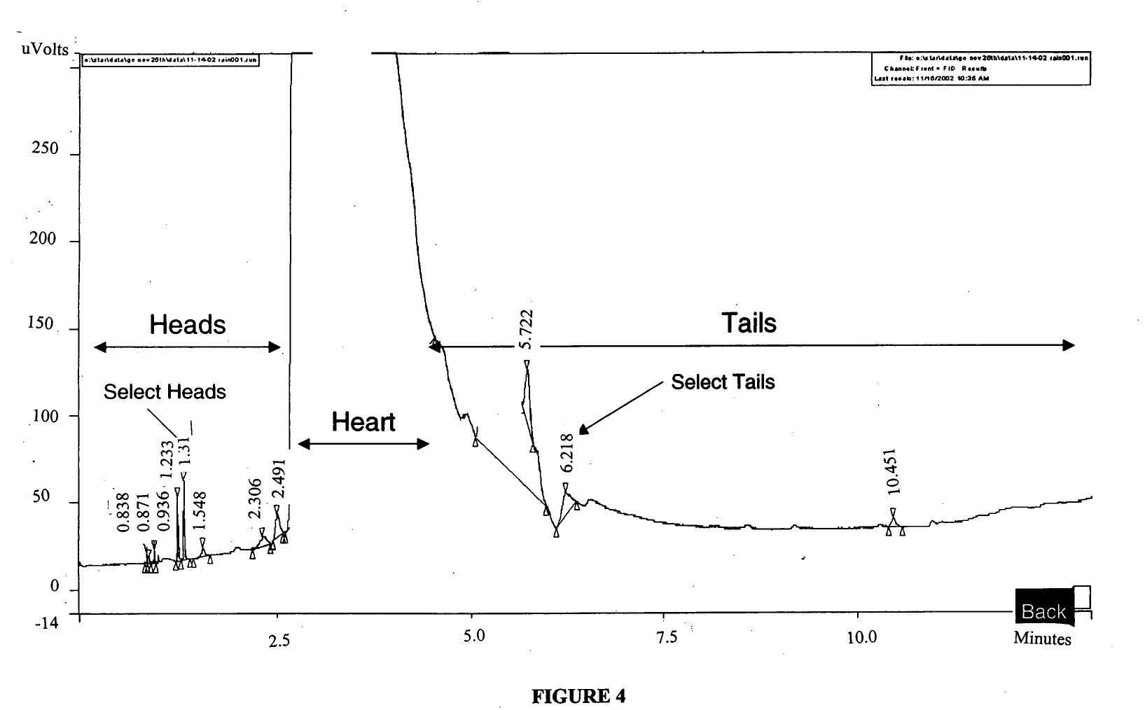

When the maximum reflux time is met, sampling of the reflux stream begins. During the sampling process, the master distiller uses a “heads and tails” method or means for drawing product from the distillate stream that allows certain desired alcohols (i.e., the heart of the distillation stream) to be retained while other undesirably alcohols (i.e., the heads and tails of the distillation stream) are kept out of the resulting vodka. This step requires careful management by the distiller to sort out and capture only the desirable alcohols and other products. The desirable alcohols consist primarily of ethanol with minute amounts of congeners or chemical compounds produced with ethanol during the fermentation process. When had and tails method begins, the temperature of the closed column still is approximately 171° F. The distiller samples the distillate stream approximately every 5 minutes to test the flavor, odor and appearance of the stream to determine exactly when to start capturing the desirable alcohols. When the distiller determines the distillate stream contains the appropriate flavor, odor and appearance, the distiller begins to draw product from the stream. Typically, the temperature of the closed column still changes to 172-173° F. to signal the transition from the undesirably low boiling point alcohols (i.e., the heads) to the desirable alcohols (i.e., the heart). Product is drawn from the stream by opening a product tank valve that diverts the distillation stream to a product tank. The distiller continues to sample and test the flavor, odor and appearance of the distillate stream every 5 minutes as the product is drawn. Product is continually drawn and retained from the distillate stream until the master distiller determines that all of the desirable alcohols have been retained. When the distiller determines the transition from the desirable alcohols to the high boiling point alcohols (i.e., the tails), the distiller redirects the high boiling point alcohols away from the product stream. High boiling point alcohols are diverted away from the product stream by closing the product tank valve. Typically, the temperature of the closed column still begins to rise from 173° F. to signal the transition from the desirably alcohol to the undesirable high boiling point alcohols. The desirable alcohols result in the vodka produced by the present invention. FIG. 4 is a gas chromatograph analysis of the high quality vodka produced by the present invention. As shown in FIG. 4, the vodka contains ethanol and small quantities of congeners, which lend to the taste and smoothness of the vodka.

The fourth through the seventh distillations are polishing steps. In the fourth distillation, the ½ of the vodka produced from the third distillation is transferred to and distilled in a doubler. The doubler removes particulates or solids (i.e. rust, grain particles, etc.) from the vodka to produce a smooth, clear product. The doubler contains a spiral heating coil or heating apparatus to heat the vodka. As the vodka vaporizes during the heating process, the remaining ½ of the vodka produced from third distillation is added to the doubler. The vaporized vodka is collected, condensed and sent back to the doubler. The doubler distillation is repeated four times.

The vodka produced from the process of the present invention contains no particulates or obscurations and preferably has a pH of 7.0. In step 5 or the resting step, the vodka resulting from the distillation process is stored in a special holding tank for approximately 3 months. Preferably, the holding tank is stainless steel. Storing the vodka in the holding tank for several months allows the vodka to thoroughly mix and experience a final smoothing through its interaction with oxygen.

In step 6 or the bottling step, limestone water is added to the vodka to bring the vodka to 80 proof (i.e., bottling proof). The limestone water is filtered though a reverse osmosis filtration system. Reverse osmosis, also known as hyper filtration, purifies the vodka by removing salts and other impurities to improve the color and taste of the vodka. The reverse osmosis filtration system utilized in the present invention uses a membrane that is semi-permeable, allowing the vodka that is being purified to pass through it, while rejecting the contaminants that remain. The reverse osmosis system uses a process known as cross flow to allow the membrane to continually clean itself. As some of the vodka passes through the membrane the rest continues downstream, sweeping the rejected contaminants away from the membrane. After the addition of limestone water, the vodka is filtered through filtration pads just prior to bottling. The filtration pads filter out dust, fiber and all other residual particles.

In the foregoing specification, the present invention has been described with reference to specific exemplary embodiments thereof. It will be apparent to those skilled in the art, that a person understanding this invention may conceive of changes or other embodiments or variations, which utilize the principles of this invention without departing from the broader spirit and scope of the invention. The specification and drawings are, therefore, to be regarded in an illustrative rather than restrictive sense.

1. A process for producing vodka comprising the steps of:
milling white organic corn to produce a corn mash;
cooking the corn mash in a cooker operating at temperature of about 240° F. and pressure of about 20 psi for about 1 hour;
transferring the cooked corn mash to circulation tank and maintaining the cooked corn mash at about 80° F. for at least 40 minutes;
transferring the cooked corn mash to fermentation tanks and adding yeast and chilled water at a temperature of 110° F.;
fermenting the cooked corn mash at a temperature of about 68-70° F. for at least 5 days;
distilling the corn mash in a beer still to produce a first mixture containing at least 60% alcohol be volume;
distilling the first mixture in a kettle still to produce a second mixture containing at least 80% alcohol by volume;
distilling the second mixture in a closed column still to produce a third mixture;
distilling the third mixture in a doubler to produce a fourth mixture;
transferring the fourth mixture to a storage tank and storing the fourth mixture for at least 3 months; and
adding limestone water to the fourth mixture to produce vodka having at least 45% alcohol by volume, wherein the limestone water is subjected to a reverse osmosis filtration process prior to adding the limestone water to the fourth mixture.

2. The process of claim 1 wherein a batch size of no more than 20,000 gallons is used to produce the vodka and the second mixture is distilled in the closed column still using the steps comprising of:
heating the second mixture at a temperature of about 170-174 F. to vaporize alcohols contained in the second mixture;
collecting and condensing the vaporized alcohols to create a distillate stream;
refluxing the distillate stream back through the closed column for at least 1.5 hours before testing the distillate stream for taste, odor and appearance; and
using a means for drawing product from the distillate stream to retain only the desirable alcohols in the distillate stream to produce the third mixture.

3. The process of claim 1 wherein a batch size of no more than 25,000 gallons is used to produce the vodka and the second mixture is distilled in the closed column still using the steps comprising of:
heating the second mixture at a temperature of about 170-174 F. to vaporize alcohols contained in the second mixture;
collecting and condensing the vaporized alcohols to create a distillate stream;
refluxing the distillate stream back through the closed column for at least 2.0 hours before testing the distillate stream for taste, odor and appearance; and
using a means for drawing product from the distillate stream to retain only the desirable alcohols in the distillate stream to produce the third mixture.

4. The process of claim 1 wherein a batch size of no more than 30,000 gallons is used to produce the vodka and the second mixture is distilled in the closed column still using the steps comprising of:
heating the second mixture at a temperature of about 170-174 F. to vaporize alcohols contained in the second mixture;
collecting and condensing the vaporized alcohols to create a distillate stream;
refluxing the distillate stream back through the closed column for at least 2.5 hours before testing the distillate stream for taste, odor and appearance; and
using a means for drawing product from the distillate stream to retain only the desirable alcohols in the distillate stream to produce the third mixture.

5. The process of claim 1 wherein a batch size of no more than 35,000 gallons is used to produce the vodka and the second mixture is distilled in the closed column still using the steps comprising of:
heating the second mixture at a temperature of about 170-174 F. to vaporize alcohols contained in the second mixture;
collecting and condensing the vaporized alcohols to create a distillate stream;
refluxing the distillate stream back through the closed column for at least 3.0 hours before testing the distillate stream for taste, odor and appearance; and
using a means for drawing product from the distillate stream to retain only the desirable alcohols in the distillate stream to produce the third mixture.

6. The process of claim 1 wherein a batch size of no more than 40,000 gallons is used to produce the vodka and the second mixture is distilled in the closed column still using the steps comprising of:
heating the second mixture at a temperature of about 170-174 F. to vaporize alcohols contained in the second mixture;
collecting and condensing the vaporized alcohols to create a distillate stream;
refluxing the distillate stream back through the closed column for at least 3.5 hours before testing the distillate stream for taste, odor and appearance; and
using a means for drawing product from the distillate stream to retain only the desirable alcohols in the distillate stream to produce the third mixture.

7. The process of claim 1 wherein a batch size of no more than 45,000 gallons is used to produce the vodka and the second mixture is distilled in the closed column still using the steps comprising of:
heating the second mixture at a temperature of about 170-174 F. to vaporize alcohols contained in the second mixture;
collecting and condensing the vaporized alcohols to create a distillate stream;
refluxing the distillate stream back through the closed column for at least 4.0 hours before testing the distillate stream for taste, odor and appearance; and
using a means for drawing product from the distillate stream to retain only the desirable alcohols in the distillate stream to produce the third mixture.
